(19) United States
(12) Patent Application Publication
(10) Pub. No.: US 2020/0122892 A1
(43) Pub. Date: Apr. 23, 2020

(54) PLASTIC ENVELOPE SUITABLE FOR MAIL AUTOMATION

(71) Applicant: EnvyPak, Inc., Dublin, OH (US)

(72) Inventors: Ross O. Youngs, Dublin, OH (US); Michele H. Cole, Dublin, OH (US); Clinton C. Cole, Columbus, OH (US); Sean M. Bannon, Indianapolis, IN (US); Gerald A. Greider, Marysville, OH (US); David R. Coho, Dublin, OH (US)

(73) Assignee: EnvyPak, Inc., Dublin, OH (US)

(21) Appl. No.: 16/601,015

(22) Filed: Oct. 14, 2019

Related U.S. Application Data
(60) Provisional application No. 62/747,618, filed on Oct. 18, 2018.

(51) Int. Cl. B65D 27/04; B65D 27/14; B31B 70/60; B31B 70/88; B31B 70/81

(52) U.S. Cl. CPC B65D 27/04; B65D 27/14; B31B 2160/102; B31B 70/88; B31B 70/813; B31B 70/60

(57) ABSTRACT

The subject disclosure relates to a plastic envelope suitable for mail automation processing. In an aspect, disclosed is an envelope apparatus having a first side portion, a second side portion, a bottom portion, an opening portion, and a foldable flap portion. In an aspect, the apparatus can have a first side portion comprising a first attached portion between a first transparent sheet and a second transparent sheet. Furthermore, the apparatus can have a second side portion comprising a second attached portion between the first transparent sheet and the second transparent sheet.

### CROSS-REFERENCE TO RELATED APPLICATION

This application claims priority to and claims the benefit of priority to U.S. Patent Application No. 62/747,618, filed on Oct. 18, 2018 and entitled “Plastic Envelope Suitable for Mail Automation”. The entirety of the disclosure of the aforementioned application is considered part of, and is incorporated by reference in, the disclosure of this application.

### BACKGROUND

On a daily basis, mail carrier organizations process large volumes of mail. To keep up with the volume of mail processing demand and improve services, such carriers have developed technologies to automate mail processing activities. However, in order to be eligible for automated processing, mail pieces (e.g., letters, cards, envelopes, etc.) must conform to very specific criteria such that they can be processed in connection with carrier automation technologies. As such, there is a need for improvements to mail pieces to make them suitable for mail automation.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are apparatuses, systems, methods, and processes corresponding to plastic envelopes suitable for mail automation.

According to an embodiment, an apparatus is provided. The apparatus comprises a first side portion comprising a first attached portion between a first transparent sheet and a second transparent sheet. The apparatus also comprises a second side portion comprising a second attached portion between the first transparent sheet and the second transparent sheet. Furthermore, the apparatus comprises a bottom portion comprising a third attached portion between the first transparent sheet and the second transparent sheet. Also, the apparatus comprises an opening portion comprising a detached portion of the first transparent sheet and the second transparent sheet. The apparatus also comprises a foldable flap portion comprising a first overhang portion of the first transparent sheet that extends beyond the first attached portion and the second attached portion, wherein a first width and a second with of the first transparent sheet is longer than a third with and a fourth width of the second transparent sheet. In another embodiment, the apparatus can further comprise an ink receptive substrate portion of an outer portion of the second transparent sheet, wherein the ink receptive substrate portion comprises a height of at least 0.25 inches and a width of at least 1 inch connected to an outer surface of the second transparent sheet.

According to another embodiment, a method of manufacturing an envelope suitable for mail automation is provided. The method comprises attaching, by a first portion of an assembly machine, a first transparent sheet to a second transparent sheet based on an attachment mechanism, wherein the first transparent sheet is longer than the second transparent sheet. Furthermore, the method comprises attaching, by a second portion of the assembly machine, an ink receptive substrate portion to an outer surface of the second transparent sheet. Also, the method comprises printing, by a third portion of the assembly machine, a leading edge portion and a trailing edge portion onto an inner surface of the first transparent sheet. In another embodiment, the method can further comprise perforating, by a fourth portion of the assembly machine, a first top portion of the first transparent sheet to generate a foldable flap portion of the envelope apparatus.

### BRIEF DESCRIPTION OF THE DRAWINGS

FIG. 1A illustrates a front view diagram of an example, non-limiting apparatus 100A that is suitable for mail automation in accordance with one or more embodiments described herein.

FIG. 1B illustrates a side view diagram of an example, non-limiting apparatus 100B that is suitable for mail automation in accordance with one or more embodiments described herein.

FIG. 1C illustrates a front view diagram of an example, non-limiting apparatus 100C demonstrating a flap portion in a partially open position that is suitable for mail automation in accordance with one or more embodiments described herein.

FIG. 1D illustrates an upside down and tilted side view diagram of an example, non-limiting apparatus 100D demonstrating a flap portion in a partially open position that is suitable for mail automation in accordance with one or more embodiments described herein.

FIG. 1E illustrates a diagram with a viewpoint into an opening portion of an example, non-limiting apparatus 100E that is suitable for mail automation in accordance with one or more embodiments described herein.

FIG. 2 illustrates a flow diagram of an example, non-limiting method 200 of manufacturing an envelope suitable for mail automation in accordance with one or more embodiments described herein.

FIG. 3 illustrates a flow diagram of an example, non-limiting method 300 of manufacturing an envelope suitable for mail automation in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

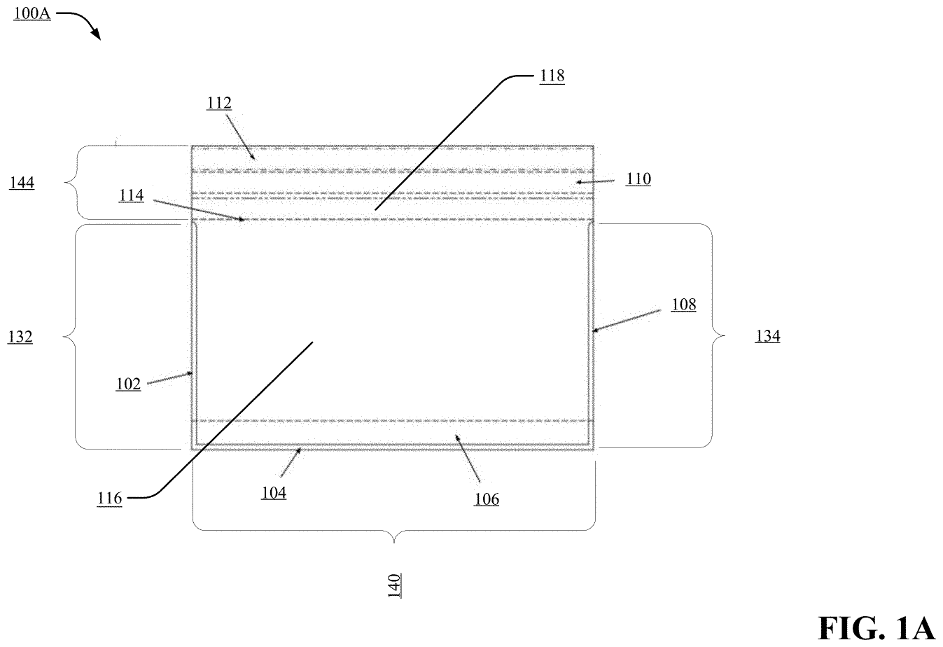

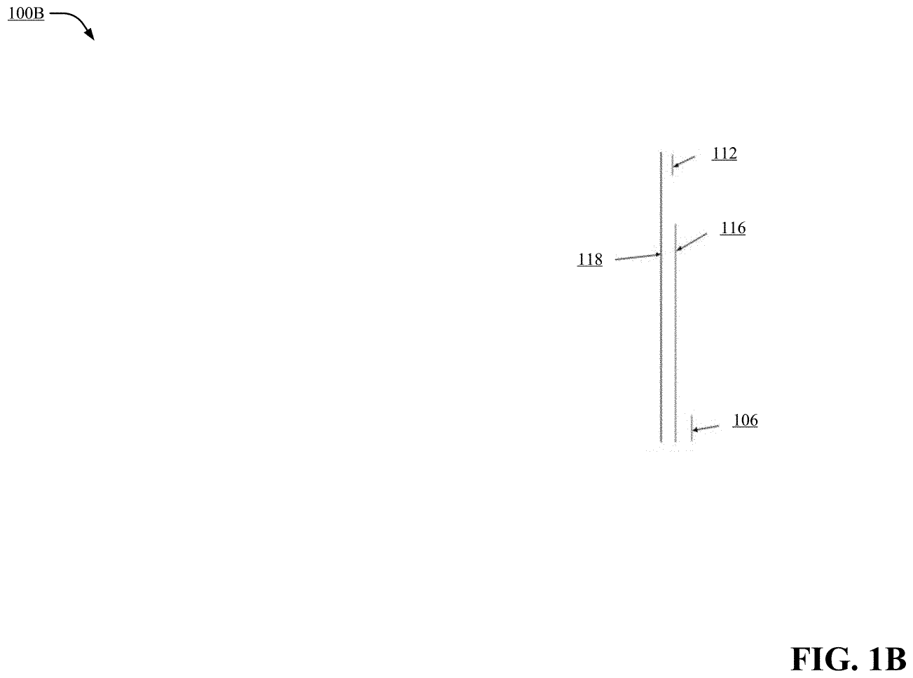

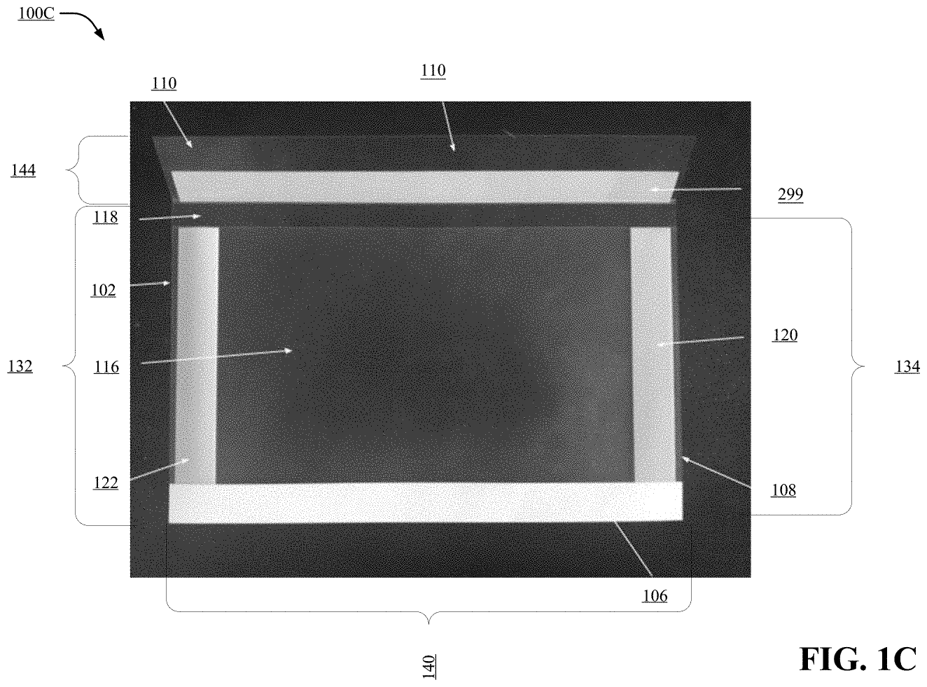

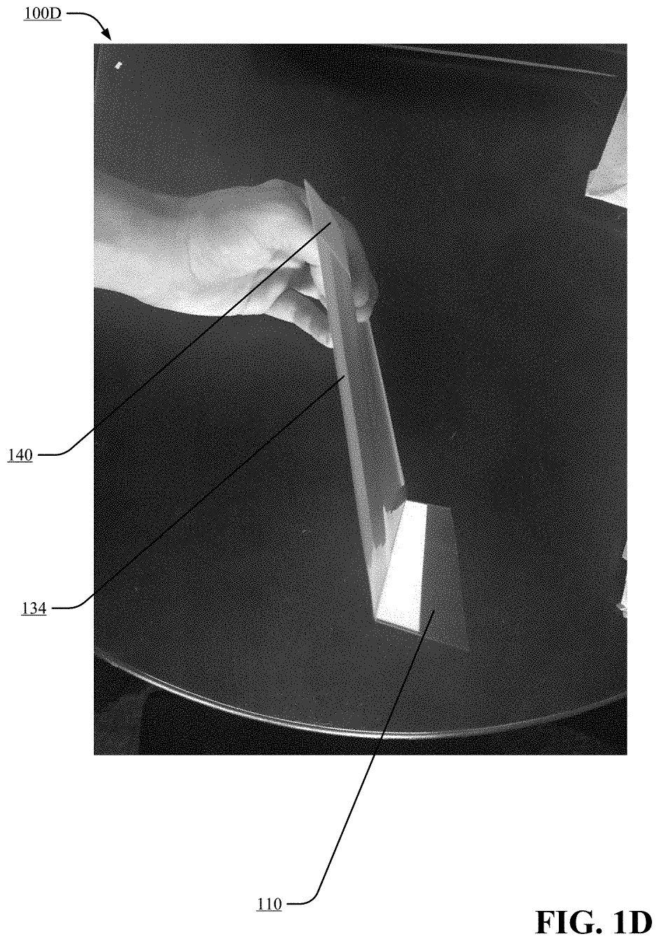

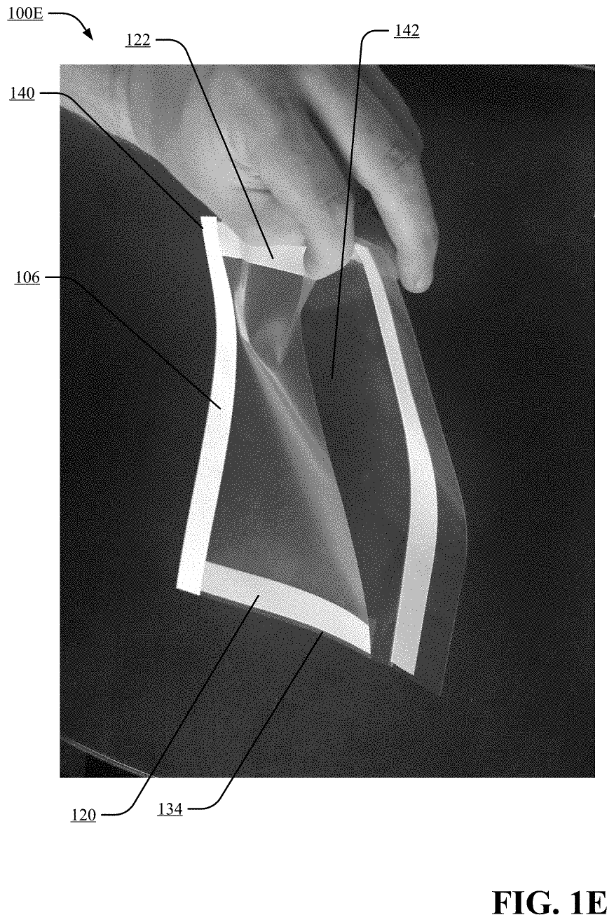

FIG. 1A illustrates a front view diagram of an example, non-limiting apparatus 100A that is suitable for mail automation in accordance with one or more embodiments described herein. In an aspect, apparatus 100A is suitable for mail automation with various mail carriers in that apparatus 100A meets mail automation criteria such as having a barcode clear zone, size requirements, shape requirements, weight requirements, and material composition requirements. As such, apparatus 100A can qualify for reduced postage costs as compared to any other plastic-based envelope, allows for reduced processing costs, allows for the inclusion of custom print, allows for reduced material and manufacturing costs, can be recycled, and is capable of having machine inserted contents or hand inserted content within its envelope containment area, such that it can be utilized with mail house automation (e.g., an organization that can insert content into an unsealed opening of apparatus 100A) and mail carrier automation technologies (e.g., automated processing of a sealed apparatus 100A). In another aspect, custom print can refer to vertical opaque print capable of improving producting and processing mechanisms of one or more mail piece. Furthermore, in an aspect, custom print can improve marketing or communication effectiveness of a mail piece or product.

In a non-limiting embodiment, apparatus 100A is configured as a clear non-paper envelope (e.g., polypropylene) capable of facilitating direct mail marketing materials (e.g., physical promotional mail sent to prospective customers) to qualify for automated postage processing for mail pieces of varying sizes (e.g., including letter size mail pieces) and cost-effective automated postage processing fees. In another aspect, apparatus 100A provides other advantages such as providing an affordable, non-paper envelope that allows for custom print to be embedded on and within the envelope and is constructed via efficient and cost-effective manufacturing processes. Furthermore, apparatus 100A can be constructed with cost-effective recyclable materials and is capable of automated insertion into various automated mail processing technologies.

In a non-limiting embodiment, apparatus 100A can comprise first side portion 132 comprising first attached portion 102 between first transparent sheet 118 and second transparent sheet 116. In another aspect, apparatus 100A can comprise second side portion 134 comprising second attached portion 108 between the first transparent sheet 118 and the second transparent sheet 116. In yet another aspect, apparatus 100A can comprise bottom portion 140 comprising third attached portion 104 between the first transparent sheet 118 and second transparent sheet 116. In another aspect, apparatus 100A can comprise opening portion 142 (not illustrated in FIG. 1A) comprising a detached portion of the first transparent sheet 118 and the second transparent sheet 116. Apparatus 100A can also include foldable flap portion 110 comprising a first overhang portion 144 of the first transparent sheet 118 that extends beyond the first attached portion 102 and the second attached portion 108, wherein a first width and a second width of the first transparent sheet 118 is longer than a third width and a fourth width of the second transparent sheet 116.

In one or more non-limiting embodiment, first transparent sheet 118 and/or second transparent sheet 116 can have a height ranging between 3.5 inches and 6.125 inches, a length of between 5 inches and 11.5 inches (to the top). In another one or more non-limiting embodiment, first transparent sheet 118 and/or second transparent sheet 116 can have a height ranging between 4 inches and 6 inches, a length of between 8.5 inches and 10.5 inches (e.g., an embodiment within automation processing standards). In another one or more non-limiting embodiment, the thickness can range between 2 millimeters to 6 millimeters. Furthermore, in one or more embodiments, the flap may range to 0.25 inches to the full height of the envelope (e.g., 0.25 inches above the full height of second transparent sheet 116).

In an aspect, a first side portion 132 of apparatus 100A can represent a side wall of an envelope suitable for mail automation and second side portion 134 can represent another side wall of the envelope. In an aspect, first side portion 132 and second side portion 134 can be formed by attaching a first transparent sheet 118 to a second transparent sheet 116. In an aspect, first transparent sheet 118 and second transparent sheet 116 can comprise a range of materials including, but not limited to, polypropylene, polyethylene, polyester, polycarbonate, vinyl (e.g., PVC), thin film plastics, and other non-paper materials. In another aspect, the first transparent sheet 118 and the second transparent sheet 116 can each be comprised of different materials. Furthermore, a non-limiting embodiment, first transparent sheet 118 and second transparent sheet 116 can each be comprised of an opaque material (e.g., via inking processes, fogging processes, etc.) having opacity properties corresponding to a range of opacity levels (e.g., corresponding to opacity values). For instance, in a non-limiting example embodiment, first transparent sheet 118 can be completely transparent (e.g., polypropylene material) and second transparent sheet 116 can be of a translucency with an opacity level of 0.5.

In yet another aspect, first transparent sheet 118 and second transparent sheet 116 can be transparent such that the contents of the apparatus 100A can be visible to a consumer. Furthermore, one or more sensors of a mail automation technology can detect various markers along the envelope and not detect the transparent portions of the envelope based on first transparent sheet 118 and second transparent sheet 116 having opacity characteristics within that satisfy a threshold opacity level required for detection by the mail automation technology. In a non-limiting embodiment, first transparent sheet 118 can be a range of shapes such as a rectangle and first transparent sheet 118 can have a larger first width and second width as compared to a third width and fourth width of second transparent sheet. As a result, first transparent sheet 118 is larger in area and size than second transparent sheet 116 thus creating first overhang portion 144 that represents a portion of first transparent sheet 118 that extends beyond second transparent sheet 116. In yet another non-limiting embodiment, first transparent sheet 118 and/or second transparent sheet 116 can comprise printed media on at least one surface. For instance, second transparent sheet 116 can comprise a printed design or printed alphanumeric characters on its surface of one or more non-limiting embodiment apparatus 100A.

In another aspect, first transparent sheet 118 can be attached to second transparent sheet 116 at a first attached portion 102 and a second attached portion 108. In an aspect, the first attached portion 102 and second attached portion 108 refers to the connecting of each transparent sheet to form the sides of the containment portion of envelope 100A. In an aspect, the connected portions of the sides can be held together via a weld mechanism, an adhesive, or a sealing mechanism. For instance, first attached portion 102 and second attached portion 108 can be united upon the surface of such portions can be prepared for welding, then heat can be applied to such materials, and the attached portions can cool down after the weld has been formed. Furthermore, in an aspect, first transparent sheet 118 and second transparent sheet 118 can be attached at the first attached portion 102 and the second attached portion 108 via any of a range of welding processes (e.g., adhesion cure welding processes), such as, hot gas welding, speed tip welding, extrusion welding, contact welding, hot plate welding, non-contact welding, high frequency welding, induction welding, injection welding, ultrasonic welding, friction welding, spin welding, laser welding, solvent welding, or any other thermal, mechanical or electromagnetic welding methods.

In other non-limiting embodiments, first transparent sheet 118 can be attached to second transparent sheet 116 using an adhesion mechanism and/or sealing mechanism. In another aspect, apparatus 100A can comprise a bottom portion 140 comprising a third attached portion 102 between the first transparent sheet 118 and the second transparent sheet 116. In an aspect, bottom portion 140 can form an attachment (e.g., third attachment portion 104) between first transparent sheet 118 and the second transparent sheet 116 in any of a range of manners that are the same as the attachment mechanisms for first attached portion 102 and second attached portion 108. For instance, third attachment portion 104 can be a weld, adhesive mechanism, or sealing mechanism that holds together first transparent sheet 118 and second transparent sheet 116 to form a bottom containment portion (e.g., bottom portion 140) of envelope apparatus 100A that is capable of holding and supporting mail contents.

In another aspect, device 100A can comprise an opening portion 142 comprising a detached portion of the first transparent sheet 118 and the second transparent sheet 116. Accordingly, opening portion 142 can include a detached portion of the first transparent sheet 118 and second transparent sheet 116. Thus, opening portion 142 represents a side of the envelope that is not attached or welded and therefore provides an opening capable of receiving content items such as direct mail, flyers, posters, and other such items for mailing. In an aspect, mail items can be hand inserted or machine inserted into opening portion 142.

In yet another aspect, device 100A can comprise foldable flap portion 110 comprising a first overhang portion 144 of the first transparent sheet 118 that extends beyond the first attached portion 102 and the second attached portion 108, wherein a first width 146 and a second width 148 of the first transparent sheet 118 is longer than a third width 150 and a fourth width 152 of the second transparent sheet 116. In an aspect, foldable flap portion 110 can be represented by the portion of first transparent sheet 118 that is longer than second transparent sheet 116 and is capable of folding over to secure the inner contents of envelope apparatus 100A. In an aspect, foldable flap portion 110 can be any of a range of flaps including, but not limited to, a straight or square flap, a commercial flap (e.g., bowed or contoured shape with angled shoulders), banker flaps, wallet flaps, reverse flaps, remittance flap, bangtail flap, or baronial flap.

In another non-limiting embodiment, apparatus 100A can comprise an ink receptive substrate portion 106 of an outer portion of the second transparent sheet 116, wherein the ink receptive substrate portion 106 comprises a height of at least 0.25 inches and a width of at least 1 inch connected to an outer surface of the second transparent sheet. In a non-limiting embodiment, the height of ink receptive substrate portion 106 (e.g., barcode clear zone) can be 0.625 inches. Accordingly, the height and length requirements can meet the threshold sizing standards required by mail automation machines as a barcode clear zone. In a non-limiting embodiment, the ink receptive substrate portion 106 can be a strip of paper stock material attached (e.g., via adhesion or other connection mechanism) to an outer surface of the second transparent sheet 116. In another non-limiting embodiment, the ink receptive substrate portion 106 can be a printed portion (e.g., a layer of ink) that is printed on an outer surface of second transparent sheet 116. In one or more non-limiting embodiment, the barcode clear zone is an area that may be printed with a barcode for processing. In another one or more non-limiting embodiment, ink receptive substrate portion 106 can comprise an opaque ink and may range from height 0.5 inches to 3 inches and 4.75 inces to the full length of the envelope apparatus with the positioning being on the bottom right side of the envelope on either first transparent sheet 118 or second transparent sheet 116.

In another non-limiting embodiment, apparatus 100A can comprise seal adhesive portion 112 covering an inner surface portion of foldable flap portion 110. In an aspect, seal adhesive portion 112 can provide a mechanism for foldable flap portion 110 to connect or attach to a front portion of second transparent sheet 116 thus sealing envelope apparatus 100A. For instance, in a non-limiting example embodiment, seal adhesive portion 112 can be a peel and seal adhesive that comprises a film located on a portion of foldable flap portion 110 that acts as a release liner, which upon removal, reveals an adhesive material capable of connecting to a surface upon contacting such surface. As such, a film of seal adhesive portion 112 can be removed and foldable flap portion 110 can be folded to contact a surface of second transparent sheet 116 such that the revealed adhesive material can form a bond with second transparent sheet 116 surface and enclose apparatus 100A. In other non-limiting embodiments, seal adhesive portion 112 can be adhesives with varying bond strengths or other sealing mechanisms. In one or more non-limiting embodiment, foldable flap portion 110 can be produced with or without a sealing mechanism. The envelope flap may be sealed with the following items, but are not limited to such items, including: hot melt adhesive, fugitive adhesive or thermal, ultrasonic and/or high frequency sealing methods.

In another non-limiting embodiment, apparatus 100A can comprise first printed edge portion 122 (illustrated in FIG. 1B) representing a leading edge of apparatus 100A and second printed edge portion 120 (illustrated in FIG. 1B) representing a trailing edge of the apparatus, wherein first printed edge 122 and second printed edge portion 120 are located on a first side portion 132 and a second side portion 134 of the apparatus 100A respectively. In an aspect, first printed edge portion 122 and second printed edge 120 can be vertical columns printed on an inner surface of first transparent sheet 118 or second transparent sheet 116. As such first printed edge portion 122 and second printed edge 120 are configured to be detected by mail automation technology sensors (e.g., optical sensors), such that the sensors can detect the printed edges as boundaries of a transparent or opaque embodiment of envelope 100A. In another aspect, mail sorting equipment that can process apparatus 100A can include sorting equipment that use optical or laser-based sensors to determine the leading and trailing edges of an envelope. Each mail piece can be counted when the leading and trailing edge is verified by the sensors. In an embodiment, first printed edge portion 122 and second printed edge portion 120 can allow for the processing equipment sensors to properly detect and/or count multiple envelopes accurately. In an aspect, first printed edge 122 and second printed edge portion 120 can be printed to either or both of first transparent sheet 118 and/or second transparent sheet 116.

In yet another non-limiting embodiment, apparatus 100A can comprise score line portion 114 on the first transparent sheet 118, wherein the score line portion 114 represents a foldable seam of the foldable flap portion 110. In an aspect, score line portion 114 can provide a crease (e.g., pre-scoring on the envelope) in apparatus 100A to facilitate a folding of foldable flap portion 110 and a sealing of apparatus 100A. In another aspect, score line portion 114 can facilitate a crisp, clean fold of foldable flap portion 110. In other non-limiting example embodiments, apparatus 100A can include one or more perforation lines, score lines, deformation lines, indented to allow for folding that facilitate an opening of a sealed envelope apparatus 100A.

Turning now to FIG. 1B, illustrated is a side view diagram of an example, non-limiting apparatus 100B that is suitable for mail automation in accordance with one or more embodiments described herein. Repetitive description of like elements employed in other embodiments described herein is omitted for sake of brevity. In an aspect apparatus 100B includes all the components of apparatus 100A but for the sake of brevity and the nature of the illustrated perspective view, illustrated are ink receptive portion 106, seal adhesive portion 112, second transparent sheet 116 (e.g., second transparent sheet 116 can be a front side or back side of various envelope embodiments), and first transparent sheet 118 (e.g., first transparent sheet 118 can be a front side or back side of various envelope embodiments). In an aspect, apparatus 100B exemplifies the longer width of first transparent sheet 118 as compared to second transparent sheet 116. Furthermore, in an aspect, apparatus 100B exemplifies the capability of ink receptive portion 106 to be adhered to second transparent sheet 116. Also, the location of seal adhesive portion 112 as located on first transparent sheet 118 is exemplified as well.

Turning now to FIG. 1C, illustrated is a front view diagram of an example, non-limiting apparatus 100C demonstrating a flap portion in a partially open position that is suitable for mail automation in accordance with one or more embodiments described herein. Repetitive description of like elements employed in other embodiments described herein is omitted for sake of brevity. In an aspect apparatus 100C can include all the components of apparatus 100A and 100B but for purposes of brevity illustrates from the perspective view first attached portion 102, second attached portion 108, foldable flap portion 110, printed portion 299, ink receptive portion 106, second transparent sheet 116, first transparent sheet 118, second printed edge portion 120, first printed edge portion 122, first side portion 132, second side portion 134, bottom portion 140, first overhang portion 144. In an aspect, FIG. 1C can also include printed portion 299 (not included in FIG. 1A and FIG. 1B)

Turning now to FIG. 1D, illustrated is an upside down and tilted side view diagram of an example, non-limiting apparatus 100D demonstrating a flap portion in a partially open position that is suitable for mail automation in accordance with one or more embodiments described herein. Repetitive description of like elements employed in other embodiments described herein is omitted for sake of brevity. In an aspect apparatus 100D includes all the components of apparatus 100A, 100B, and 100C but for purposes of brevity illustrates from the perspective view foldable flap portion 110, second side portion 134, bottom portion 140, first overhang portion 144.

Turning now to FIG. 1E, illustrated is a diagram with a viewpoint into an opening portion of an example, non-limiting apparatus 100E that is suitable for mail automation in accordance with one or more embodiments described herein. Repetitive description of like elements employed in other embodiments described herein is omitted for sake of brevity. In an aspect apparatus 100E includes all the components of apparatus 100A, 100B, 100C, and 100D but for purposes of brevity illustrated are ink receptive substrate portion 106, second printed edge portion 120, first printed edge portion 122, second side portion 134, bottom portion 140, and opening portion 142

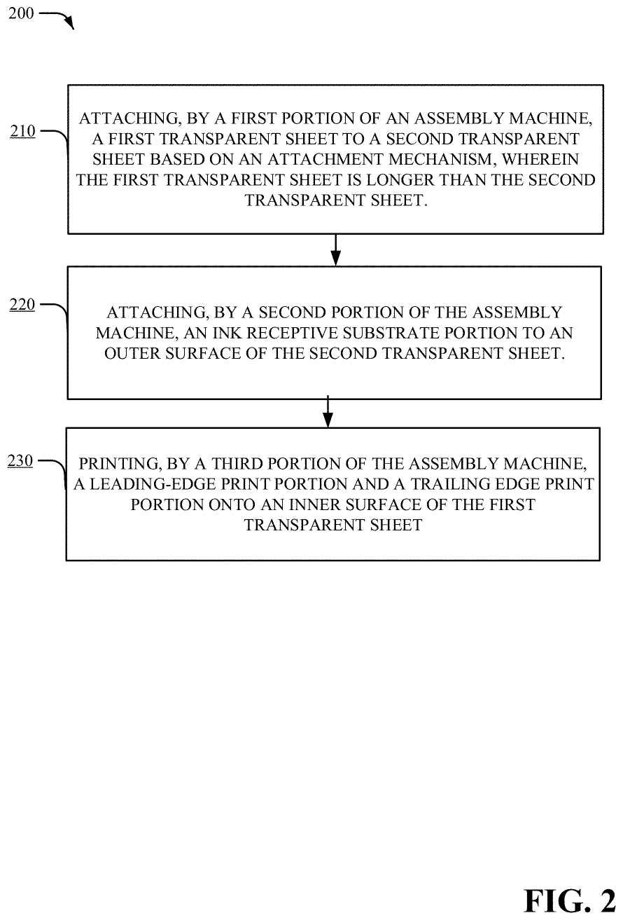

Turning now to FIG. 2, illustrated is a flow diagram of an example, non-limiting method 200 of manufacturing an envelope suitable for mail automation in accordance with one or more embodiments described herein. In an aspect, at reference numeral 210, a first portion of an assembly machine attaches (e.g., first attached portion 102 and second attached portion 108) a first transparent sheet (e.g., first transparent sheet 118) to a second transparent sheet (e.g., second transparent sheet 116) based on an attachment mechanism, wherein the first transparent sheet is longer than the second transparent sheet. At reference numeral 220, a second portion of the assembly machine attaches an ink receptive substrate portion (e.g., ink receptive substrate portion 106) to an outer surface of the second transparent sheet (e.g., second transparent sheet 116). Furthermore, at reference numeral 230, a third portion of the assembly machine prints a leading-edge print portion (e.g., first printed edge portion 122) and a trailing edge print portion (e.g., second printed edge portion 120) onto an inner surface of the first transparent sheet (e.g., first transparent sheet 118). In a non-limiting embodiment, ink receptive substrate portion 106 can be applied to first transparent sheet 118 or second transparent sheet 116.

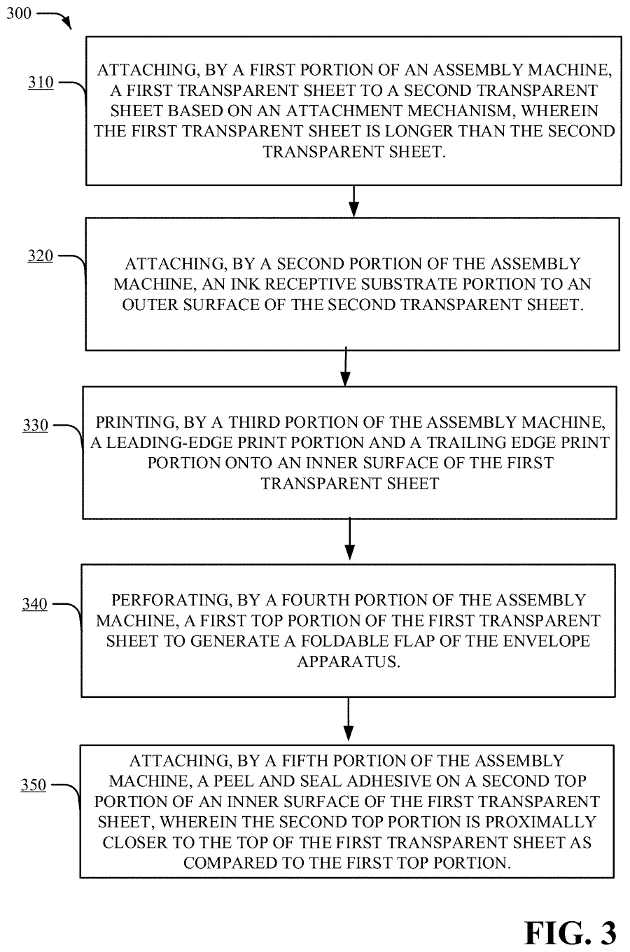

Turning now to FIG. 3, illustrated is a flow diagram of an example, non-limiting method 300 of manufacturing an envelope suitable for mail automation in accordance with one or more embodiments described herein. Repetitive description of like elements employed in other embodiments described herein is omitted for sake of brevity.

In an aspect, at reference numeral 310, a first portion of an assembly machine attaches (e.g., first attached portion 102 and second attached portion 108) a first transparent sheet (e.g., first transparent sheet 118) to a second transparent sheet (e.g., second transparent sheet 116) based on an attachment mechanism, wherein the first transparent sheet is longer than the second transparent sheet. At reference numeral 320, a second portion of the assembly machine attaches an ink receptive substrate portion (e.g., ink receptive substrate portion 106) to an outer surface of the second transparent sheet (e.g., second transparent sheet 116). Furthermore, at reference numeral 330, a third portion of the assembly machine prints a leading-edge print portion (e.g., first printed edge portion 122) and a trailing edge print portion (e.g., second printed edge portion 120) onto an inner surface of the first transparent sheet (e.g., first transparent sheet 118).

Also, at reference numeral 340, a fourth portion of the assembly machine, perforates a first top portion of the first transparent sheet to generate a foldable flap of the envelope apparatus. At reference numeral 350, a fifth portion of the assembly machine attaches a peel and seal adhesive (e.g., seal adhesive portion 112) on a second top portion of an inner surface of the first transparent sheet (e.g., first transparent sheet 118), wherein the second top portion is proximally closer to the top of the first transparent sheet as compared to the first top portion.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events.

Also, the descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus, comprising:
a first side portion comprising a first attached portion between a first transparent sheet and a second transparent sheet;
a second side portion comprising a second attached portion between the first transparent sheet and the second transparent sheet;
a bottom portion comprising a third attached portion between the first transparent sheet and the second transparent sheet;
an opening portion comprising a detached portion of the first transparent sheet and the second transparent sheet; and
a foldable flap portion comprising a first overhang portion of the first transparent sheet that extends beyond the first attached portion and the second attached portion, wherein a first width and a second width of the first transparent sheet is longer than a third width and a fourth width of the second transparent sheet.

2. The apparatus of claim 1, further comprising an ink receptive substrate portion of an outer portion of the second transparent sheet, wherein the ink receptive substrate portion comprises a height of at least 0.25 inches and a width of at least 1 inch connected to an outer surface of the second transparent sheet.

3. The apparatus of claim 1, further comprising a seal adhesive portion covering an inner surface portion of the foldable flap portion.

4. The apparatus of claim 3, wherein the seal adhesive portion is a peel and seal adhesive.

5. The apparatus of claim 1, further comprising a first printed edge portion representing a leading edge of the apparatus and a second printed edge portion representing a trailing edge of the apparatus, wherein the first printed edge portion and the second printed edge portion are located on a first side portion and a second side portion of the apparatus respectively.

6. The apparatus of claim 1, comprising a score line portion on the first transparent sheet, wherein the score line portion represents a foldable seam of the foldable flap portion.

7. The apparatus of claim 1, wherein the first transparent sheet and the second transparent sheet comprise a polypropylene material, polyethylene material, polycarbonate material, vinyl material, thin film plastic material, or an opaque material.

8. The apparatus of claim 1, wherein the first transparent sheet or the second transparent sheet comprises printed media on at least one surface.

9. The apparatus of claim 1, wherein the first attached portion, the second attached portion or the third attached portion is attached based on a weld mechanism, an adhesive, or a sealing mechanism.

10. The apparatus of claim 2, wherein the ink receptive substrate portion comprises a strip of paper stock attached to an outer surface of the second transparent sheet or a printed portion on the outer surface of the second transparent sheet.

11. The apparatus of claim 2, wherein the height is 0.625 inches.

12. A method of manufacturing an envelope apparatus suitable for mail automation comprising:
attaching, by a first portion of an assembly machine, a first transparent sheet to a second transparent sheet based on an attachment mechanism, wherein the first transparent sheet is longer than the second transparent sheet;
attaching, by a second portion of the assembly machine, an ink receptive substrate portion to an outer surface of the second transparent sheet; and
printing, by a third portion of the assembly machine, a leading-edge portion and a trailing edge portion onto an inner surface of the first transparent sheet.

13. The method of claim 12, wherein the first portion of the assembly machine performs an attachment mechanism that is at least one of a welding, a sealing, or an adhering.

14. The method of claim 12, further comprising perforating, by a fourth portion of the assembly machine, a first top portion of the first transparent sheet to generate a foldable flap portion of the envelope apparatus.

15. The method of claim 14, further comprising attaching, by a fifth portion of the assembly machine, an adhesive with removable liner on a second top portion of an inner surface of the first transparent sheet, wherein the second top portion is proximally closer to the top of the first transparent sheet as compared to the first top portion.
